(19) United States
(12) Patent Application Publication
(10) Pub. No.: US 2026/0194697 A1
(43) Pub. Date: Jul. 9, 2026

(54) GUIDED-MODE RESONANT GRATING, OPTICAL MEMBER, OPTICAL PRODUCT, AND METHOD FOR MANUFACTURING GUIDED-MODE RESONANT GRATING

(71) Applicant: TOHOKU UNIVERSITY, Sendai-shi, Miyagi (JP)

(72) Inventor: Yoshiaki KANAMORI, Sendai-shi (JP)

(73) Assignee: TOHOKU UNIVERSITY, Sendai-shi, Miyagi (JP)

(21) Appl. No.: 18/865,441

(22) PCT Filed: Jun. 14, 2023
(86) PCT No.: PCT/JP2023/022040

§ 371 Date: Nov. 13, 2024

(30) Foreign Application Priority Data
Jun. 29, 2022 (JP) 2022-104745

(51) Int. Cl. G02B 5/18; G02B 5/26

(52) U.S. Cl. CPC G02B 5/1814; G02B 5/1852; G02B 5/26

(57) ABSTRACT

A guided-mode resonant grating having a layered structure of a grating layer and a waveguide layer, wherein a refractive index difference between the grating layer and the waveguide layer is 0.1 or less, and light is made incident from a side of the waveguide layer, and a method for manufacturing the same, as well as an optical member or optical product including the guided-mode resonant grating.

### TECHNICAL FIELD

The present invention relates to a guided-mode resonant grating, and an optical member or optical product using the same. The present invention also relates to a method for manufacturing a guided-mode resonant grating.

### BACKGROUND ART

A structural color refers to a color development phenomenon caused by a fine structure having a wavelength equal to or smaller than that of light, and has a characteristic of being less likely to fade due to deterioration over time, unlike a dye or pigment. Examples of the color development phenomenon include thin film interference, multilayer interference, diffraction, diffraction grating, scattering, and wavelength dispersion. These color development phenomena can also be found in nature, for example, in the wing of a jewel beetle, the scale of a morpho, the wing of a peacock, a shell, and an opal.

A color filter is an optical device that disperses light by reflecting or transmitting light in a specific wavelength range. The color filter is used in imaging elements such as charge-coupled device (CCD) image sensors and display devices such as liquid crystal displays (LCDs). The color filter generally utilizes the ability of a dye or pigment to absorb light in a specific wavelength range. On the other hand, it is also possible to manufacture a color filter by a nano-level optical design that reflects light of a specific wavelength without using a dye or pigment, as in the case of development of the structural color as described above.

A guided-mode resonant grating (GMRG) (for example, Patent Document 1) is attracting attention as an optical element expected to develop the structural color as described above and to be applied to a color filter. The GMRG is a sub-wavelength grating wavelength selection filter. Theoretically, it has a reflectance of 100% in a narrow band. The sub-wavelength grating is obtained by shortening a period of a diffraction grating to the wavelength of light or less. An order of a diffracted wave is suppressed, and only 0 order transmitted wave and reflected wave are generated. The reflectance and transmittance characteristics of the GMRG can be changed by controlling the grating period, the grating width, and the like. For example, application of the GMRG to a wavelength selection filter for optical communication has been reported. The wavelength selection filter based on the GMRG exhibits equivalent wavelength selectivity with a smaller number of stacked layers as compared with a known thin film stacked type wavelength selection filter, and a more advanced optical design becomes possible by increasing the number of stacked layers. Further, since the optical characteristics are determined based on the grating period and the grating width, a plurality of wavelength selection elements having various wavelength selecting characteristics can be collectively fabricated on the same substrate depending on patterning of the grating even if the grating has the same height.

FIG. 1 illustrates a basic configuration of a GMRG. In a GMRG 1 illustrated in FIG. 1, a layer made of a high refractive index material 12 is disposed on a substrate made of a low refractive index material 11, and a grating (sub-wavelength grating) having a constant period is formed in the layer made of the high refractive index material by nanoimprinting or the like. That is, it has three functional layers having different optical characteristics, i.e., a substrate made of the low refractive index material 11, a grating layer made of the high refractive index material 12, and a waveguide layer located between the substrate and the grating layer and made of the high refractive index material 12. The GMRG 1 having this structure allows light of various wavelengths incident from the grating layer side to be filtered by controlling a grating period A and a fill factor (w/A) (FIG. 2).

### CITATION LIST

### Patent Literature

Patent Document 1: WO 2019/039371

### SUMMARY OF INVENTION

### Technical Problem

As described above, the known GMRG requires a combination of a low refractive index material and a high refractive index material. Since the difference in refractive index characteristics is usually caused by the difference in physical/chemical characteristics between material species, the known GMRG has a problem of difficulty in obtaining sufficient interlayer adhesion. In addition, there is a problem of difficulty in integrally forming the layer structure also in terms of manufacturing the GMRG.

An object of the present invention is to provide a GMRG made of a single material or a combination of materials having a small refractive index difference, and to provide a method for manufacturing the same. Another object of the present invention is to provide an optical member including the GMRG, and a product including the optical member.

As a result of intensive studies in light of the above problems, the present inventors have found that a GMRG that selectively reflects light of a desired wavelength with high efficiency even when each functional layer of the GMRG is made of a single material can be provided by adopting a new layered configuration different in concept from the layered configuration of each functional layer in a known GMRG with a side on which incident light is incident as a reference. The present invention has been completed by further studies based on the finding.

### Solution to Problem

The issues of the present invention have been solved by the following means.
[1]

A guided-mode resonant grating having a layered structure of a grating layer and a waveguide layer, wherein a refractive index difference between the grating layer and the waveguide layer is 0.1 or less, and light is made incident from a side of the waveguide layer.
[2]

The guided-mode resonant grating according to [1], including a substrate, the grating layer, and the waveguide layer in this order.
[3]

The guided-mode resonant grating according to [1] or [2], wherein a constituent material for the grating layer and a constituent material for the waveguide layer are the same.
[4]

The guided-mode resonant grating according to [2], wherein a constituent material for the substrate, a constituent material for the grating layer, and a constituent material for the waveguide layer are the same.
[5]

The guided-mode resonant grating according to any one of [1] to [4], wherein the grating layer has a grating period of from 0.26 to 0.60 μm.
[6]

The guided-mode resonant grating according to any one of [1] to [5], wherein the grating layer has a thickness of 0.20 μm or more.
[7]

The guided-mode resonant grating according to any one of [1] to [6], wherein the grating layer has a volume occupancy of from 0.15 to 0.65.
[8]

The guided-mode resonant grating according to any one of [1] to [7], wherein the waveguide layer has a thickness of from 0.05 to 1.00 μm.
[9]

The guided-mode resonant grating according to any one of [1] to [8], wherein a periodic structure of the grating layer is a two dimensional periodic structure.

An optical member including the guided-mode resonant grating according to any one of [1] to [9].

The optical member according to [10], wherein the optical member is a structural color development member or a wavelength selection filter.

An optical product including the optical member according to or [11].

A method for manufacturing the guided-mode resonant grating according to any one of [1] to [9], including: forming a grating periodic structure by patterning a resist film on the substrate, or forming a grating periodic structure by pressing a mold against a resin base material; and
forming the waveguide layer by thermally melting a grating surface of the grating periodic structure to deform the surface and a vicinity thereof and joining adjacent gratings to each other.

A method for manufacturing the guided-mode resonant grating according to any one of [1] to [9], including:
forming a grating periodic structure by patterning a resist film on the substrate, or forming a grating periodic structure by pressing a mold against a resin base material; and
forming the waveguide layer on a grating surface of the grating periodic structure by a pressure bonding method, a spin coating method, a vapor deposition method, a sputtering method, or a method of depositing resin particles larger than a width of an opening of the grating periodic structure on the grating periodic structure.

A method for manufacturing the guided-mode resonant grating according to any one of [1] to [9], including pressing a mold against a resin layer on the base material to form a grating periodic structure, and then removing the base material layer.

A method for manufacturing the guided-mode resonant grating according to any one of [1] to [9], including pressing a mold against a resin layer on a base material to form a grating periodic structure, joining a side of the grating periodic structure onto the substrate, and then removing the base material.

### Advantageous Effects of Invention

The GMRG of the present invention has a new layered configuration different in concept from the layered configuration of a known GMRG, and can selectively reflect light of a desired wavelength with high efficiency even though it is made of a single material or a combination of materials having a small refractive index difference. In addition, in the GMRG of the present invention, the grating layer is not exposed on the incident light side surface but is located inside the waveguide layer, and thus irregularities of the grating layer are not directly exposed to scratching or wiping, for example, during cleaning and durability is also excellent. The optical member or product of the present invention includes the above-described GMRG of the present invention, and can have further enhanced stabilities (interlayer adhesion and durability) of the layered structure of the GMRG, and, as a result, reliability of the optical characteristics is further enhanced.

### BRIEF DESCRIPTION OF DRAWINGS

FIG. 1 is a schematic view illustrating a basic configuration of a known guided-mode resonant grating.

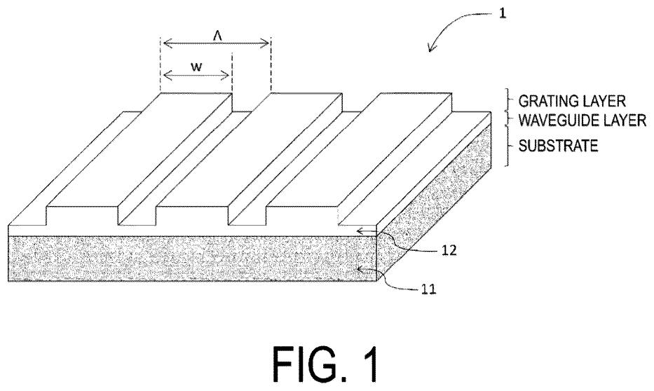

FIG. 2 shows reflection peak spectra showing that the known guided-mode resonant grating can filter light of various wavelengths by controlling a grating period A and a fill factor (w/A).

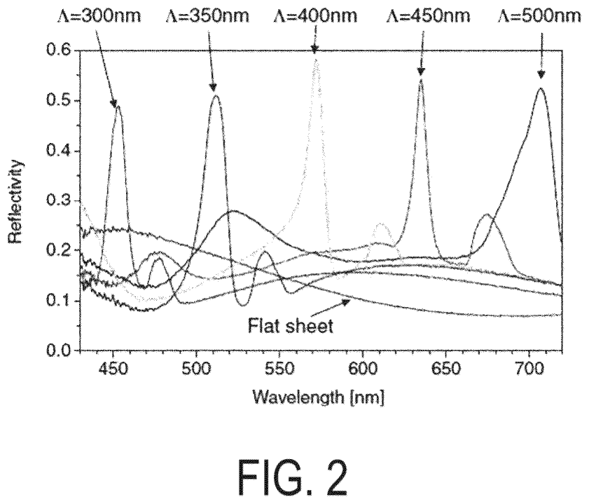

FIG. 3 is a schematic view illustrating a preferred embodiment of a guided-mode resonant grating of the present invention.

FIG. 4 is a graph showing dependence of reflection spectra on a grating period (Λ) in the preferred embodiment of the guided-mode resonant grating of the present invention.

FIG. 5 is a graph showing dependence of the reflection spectra on a grating width (w) in the preferred embodiment of the guided-mode resonant grating of the present invention.

FIG. 6 is a graph showing dependence of the reflection spectra on a waveguide layer thickness (h1) in the preferred embodiment of the guided-mode resonant grating of the present invention.

FIG. 7 is a graph showing dependence of the reflection spectra on a grating layer thickness (h2) in the preferred embodiment of the guided-mode resonant grating of the present invention.

FIG. 8 shows an example of the reflection spectra when parameters for realizing high reflection efficiency are adopted for each of RGB in the preferred embodiment of the guided-mode resonant grating of the present invention.

FIG. 9 shows dependence of the reflection spectra on a volume occupancy in the preferred embodiment of the guided-mode resonant grating of the present invention.

FIG. 10 shows the dependence of the reflection spectra on the grating layer thickness (h2) in the preferred embodiment of the guided-mode resonant grating of the present invention.

FIG. 11 shows the dependence of the reflection spectra on the waveguide layer thickness (h1) in the preferred embodiment of the guided-mode resonant grating of the present invention.

FIG. 12 shows the dependence of the reflection spectra on the grating period (Λ) in the preferred embodiment of the guided-mode resonant grating of the present invention.

FIG. 13 is an explanatory view illustrating an example of a method for manufacturing the guided-mode resonant grating of the present invention.

FIG. 14 is an explanatory view illustrating the example of the method for manufacturing the guided-mode resonant grating of the present invention.

FIG. 15 is an explanatory view illustrating an example of the method for manufacturing the guided-mode resonant grating of the present invention.

FIG. 16 is an explanatory view illustrating an example of the method for manufacturing the guided-mode resonant grating of the present invention.

FIG. 17 is an explanatory view illustrating an example of the method for manufacturing the guided-mode resonant grating of the present invention.

FIG. 18 is an explanatory view illustrating an example of the method for manufacturing the guided-mode resonant grating of the present invention.

FIG. 19 is an explanatory view illustrating a method of calculating a filling factor (FF).

### DESCRIPTION OF EMBODIMENTS

### Guided-Mode Resonant Grating

A guided-mode resonant grating (GMRG) of the present invention has a layered structure of a grating layer and a waveguide layer, and a refractive index difference between the grating layer and the waveguide layer (which means an absolute refractive index difference value at 25° C., the same applies hereinafter) is 0.1 or less. That is, the GMRG of the present invention is made of a single material or a combination of materials having similar properties and a small refractive index difference. The GMRG of the present invention is used in a mode in which light is made incident from a side of the waveguide layer.

Also, the GMRG of the present invention preferably has a structure of including a substrate, the grating layer and the waveguide layer in this order. In this case, the refractive index difference between the substrate and the grating layer is not particularly limited. The substrate may be made of a transparent material such as a transparent resin, silica, or quartz, and may be chromatic or achromatic. In consideration of improvement in manufacturing efficiency and interlayer adhesion, the substrate and the grating layer are preferably resins having similar properties. Also, from this viewpoint, the refractive index difference between the substrate and the grating layer is preferably 0.08 or less, more preferably 0.06 or less, more preferably 0.04 or less, and more preferably 0.02 or less, and the substrate and the grating layer are preferably made of the same material. Therefore, in a preferred embodiment of the GMRG of the present invention, the GMRG has a layered configuration in which a substrate, a grating layer and a waveguide layer are disposed in this order, and a constituent material for the substrate, a constituent material for the grating layer and a constituent material for the waveguide layer are all the same.

Hereinafter, embodiments of the GMRG of the present invention will be described with reference to the drawings. It should be noted that the drawings are explanatory views for facilitating the understanding of the present invention, that sizes of members, relative size relationships thereof, and the like may be changed for convenience of explanation, and that the drawings do not directly show actual relationships. Further, the present invention is not limited to the outer shapes and shapes shown in these drawings except for matters defined in the present invention.

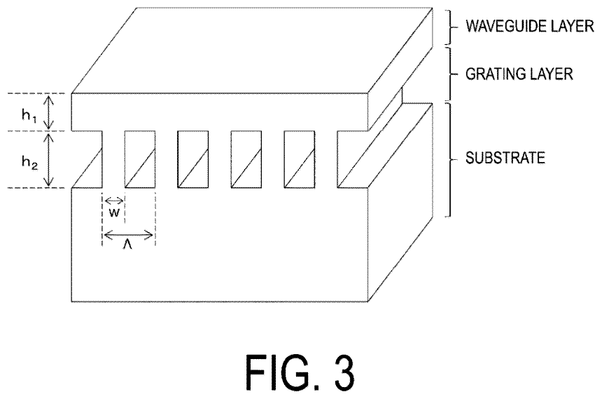

FIG. 3 is a perspective view schematically showing a preferred embodiment of the GMRG of the present invention. As illustrated in FIG. 3, the GMRG of the present invention has a layered structure of a grating layer and a waveguide layer. In the embodiment illustrated in FIG. 3, the GMRG includes a substrate on a side of the grating layer opposite to the waveguide layer. The substrate, the grating layer and the waveguide layer are made of the same material (polymethyl methacrylate (PMMA), refractive index: 1.5). Therefore, as will be described later, the substrate and the grating layer or the grating layer and the waveguide layer can be integrally formed.

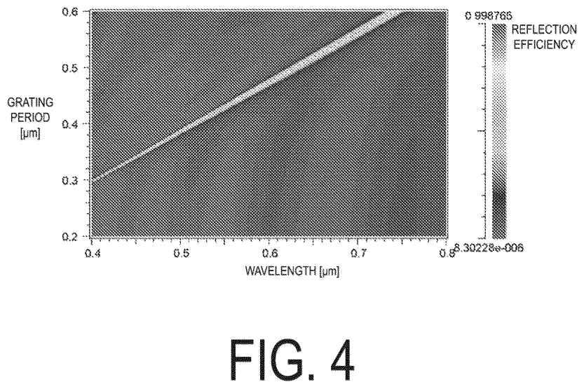

FIGS. 4 to 7 show simulation results of reflection characteristics with respect to incident light from the waveguide layer side by a rigorous coupled-wave analysis (RCWA) method when a grating period (Λ) of the grating layer, a grating width (w) of the grating layer, a thicknesses (h1) of the waveguide layer, and a thickness (h2) of the grating layer are each changed in the GMRG illustrated in FIG. 3. In the simulation, DiffractMOD available from Synopsys was used as numerical calculation software. Set values in the simulation are as follows. The grating shape of the grating layer is a so-called one dimensional shape (one dimensional periodic structure), and cavities are linearly formed in a depth direction from the front side in FIG. 3. In the above simulation, the incident light is TE polarized light (electric field of the incident light is parallel to grooves of the grating). A shape of the cavity on the waveguide layer or substrate side may be tapered.
Harmonics: 10
Calculation wavelength step: 2 nm
Calculation grating period step: 4 nm
Calculation grating width step: 4 nm
Calculation waveguide layer thickness step: 4 nm
Calculation grating layer thickness step: 10 nm

FIG. 4 is a graph showing dependence of reflection spectra on the grating period (Λ), where the grating width (w)=200 nm, the waveguide layer thickness (h₁)=150 nm, and the grating layer thickness (h₂)=1000 nm. It can be seen that a peak of a reflection wavelength changes with the change in grating period (Λ). That is, it can be seen that at least a desired wavelength in a visible light region can be reflected by controlling the grating period. In FIG. 4, a maximum efficiency portion at the center of a highest reflection efficiency region (in the black and white drawing, a white region indicates a maximum reflection efficiency region) is indicated by a broken line.

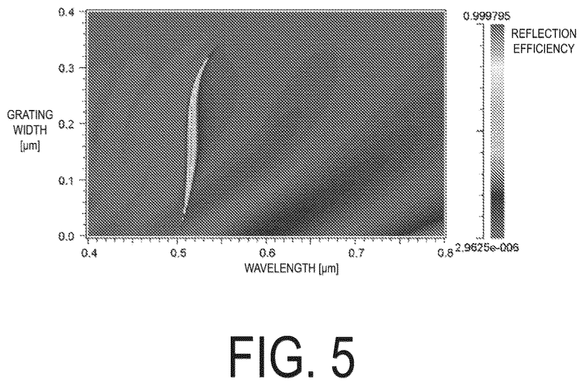

FIG. 5 is a graph showing dependence of the reflection spectra on the grating width (w), where the grating period (Λ)=400 nm, the waveguide layer thickness (h₁)=150 nm, and the grating layer thickness (h₂)=1000 nm. It can be seen that high reflection efficiencies are exhibited at grating widths of about from 20 to 320 nm (from 0.02 to 0.32 μm) in a vicinity of wavelengths exceeding 0.5 μm. In addition, it can be seen that high reflection efficiencies are exhibited at grating widths of about from 100 to 250 nm (from 0.1 to 0.25 μm). In the present embodiment (one dimensional grating shape), the grating width (w) dependence is observed. The grating width (w) in the one dimensional grating shape is an element substantially equivalent to a volume occupancy which will be described later, and is a main element for determining an effective refractive index of the grating layer (average refractive index of the entire grating layer).

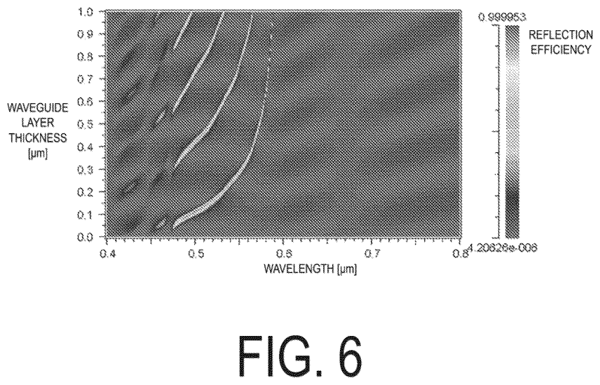

FIG. 6 is a graph showing dependence of the reflection spectra on the waveguide layer thickness (h₁, where the grating period (Λ)=400 nm, the grating width (w)=200 nm, and the grating layer thickness (h₂)=1000 nm. When the waveguide layer has a thickness of 300 nm or less (0.3 μm or less), there is one reflection peak (single mode). When the waveguide layer is thicker than that, there are two reflection peaks (multimode). When the waveguide layer has a thickness of less than 50 nm (0.05 μm), the reflection peak disappears.

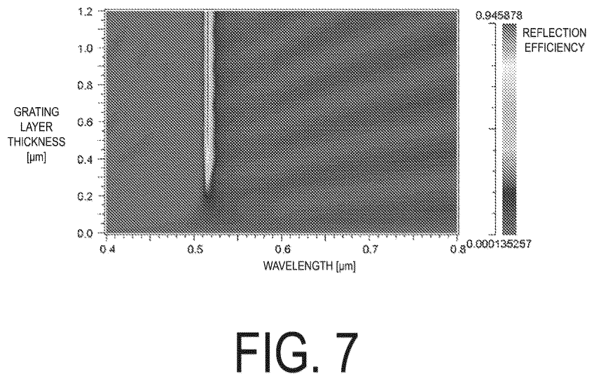

FIG. 7 is a graph showing dependence of the reflection spectra on the grating layer thickness (h₂), where the grating period (Λ)=400 nm, the grating width (w)=200 nm, and the waveguide layer thickness (h₁)=150 nm. It can be seen from this figure that the thicker the grating layer is (the larger an aspect ratio is), the higher the reflection efficiency is.

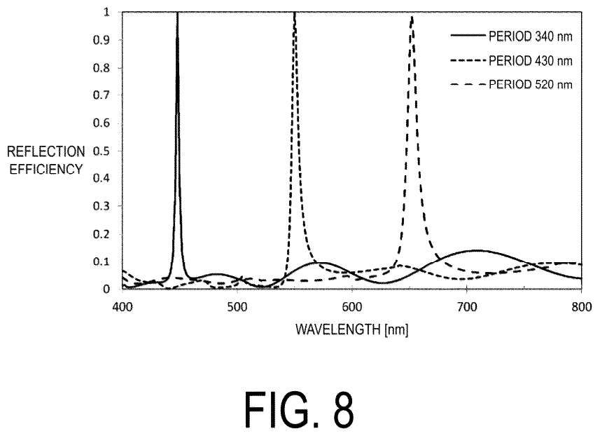

The above-described simulation was performed under various conditions, and combinations shown in the following table were adopted as parameters for realizing high reflection efficiency for each wavelength region of RGB (red, green, and blue). The reflection spectra at the parameters are shown in FIG. 8. As shown in FIG. 8, the maximum reflection efficiency of the blue region (B) was 99.9%, the maximum reflection efficiency of the green region (G) was 99.9%, and the maximum reflection efficiency of the red region (R) was 98.8%.

### [Table 1]

TABLE 1

| | Grating | Grating | Waveguide layer | Grating layer |
|---|---|---|---|---|
| Reflection peak | period | width | thickness | thickness |
| wavelength (nm) | (Λ, nm) | (w, nm) | (h₁, nm) | (h₂, nm) |
| 448 (blue) | 340 | 108 | 150 | 1000 |
| 550 (green) | 430 | 228 | 150 | 1000 |
| 652 (red) | 520 | 260 | 150 | 1000 |

As described above, it can be seen that, when the layered structure of the grating layer and the waveguide layer is formed of a single material or a combination of materials having similar characteristics and a small refractive index difference, light incident from the waveguide layer side can be reflected with high efficiency. The reason for this is considered as follows.

Since the waveguide layer has a function of confining light, the refractive index of the waveguide layer must be higher than that of a surrounding medium. In the above embodiment, the grating layer is made of a material having the same refractive index as that of the material for the waveguide layer, but the effective refractive index is an average value depending on the volume occupancies of the grating material and the material (for example, air) in gaps between the gratings. Therefore, the refractive index of the waveguide layer is considered to be higher than the effective refractive index of the grating layer and to satisfy the condition of the magnitude relationship of the refractive index for functioning as the waveguide layer. In addition, the grating layer has wavelength selectivity and a function as an optical input/output coupler to the waveguide layer, and, when the grating layer and the waveguide layer are close to each other to such an extent that optical propagation modes of the grating layer and the waveguide layer (in the optical propagation mode, light leaks out from a surface of each layer by about one wavelength as near-field light) overlap each other, the grating layer and the waveguide layer are optically coupled to each other. As the point of the present invention, the light confined in the waveguide layer (in the optical propagation mode of the waveguide layer, light leaks out from the waveguide layer by about one wavelength as near-field light) needs to be separated from the substrate to such an extent that it is not optically coupled with the substrate, and, therefore, it is considered that this problem can be avoided by thickening the grating layer to a certain extent and the GMRG can be realized by a single material including the substrate.

Next, also in the case of a square grating in which the grating shape of the grating layer is a so-called two dimensional shape (two dimensional periodic structure), a simulation was performed on the assumption that the substrate, the grating layer, and the waveguide layer are made of PMMA in the same manner as described above. The square grating is a grating shape in which a hole (space) of a concave portion is square when the grating layer is observed in a plan view from a side on which incident light is incident supposing that the waveguide layer is removed in FIG. 3. If desired reflection spectra can be realized by forming the grating shape into a two dimensional shape, polarization dependence at the time of vertical incidence can be eliminated, and practical superiority can be enhanced. In this simulation, TE polarized light usable in the software described above is used as the incident light.

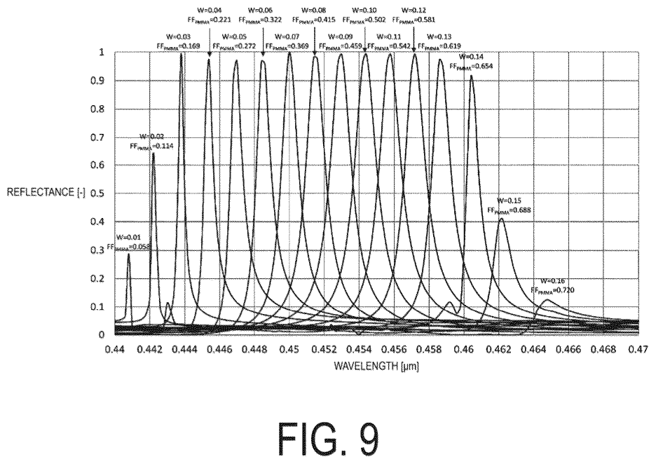

FIG. 9 shows reflection spectra when the grating period (Λ) of the grating layer is 0.340 μm, the thickness (h₂) of the grating layer is 1.00 μm, the thickness (h₁) of the waveguide layer is 0.15 μm, and the grating width (w) is changed to change the volume occupancy of a PMMA portion in the grating layer (FF_{PMMA}, where FF is an abbreviation of filling factor). In the present invention, the mere “volume occupancy” refers to a ratio of the grating material portion (e.g., PMMA portion) to a volume of the entire grating layer (grating material portion+space portion).

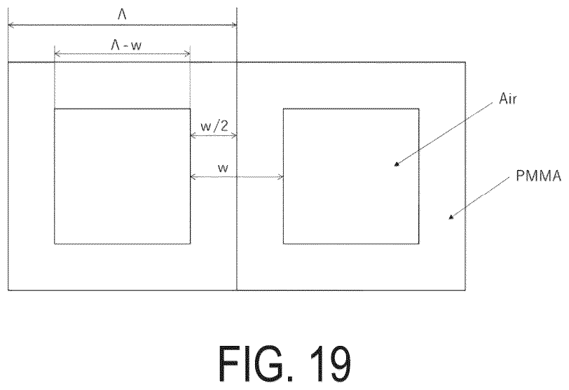

Here, a method of calculating the volume occupancy (FF_{PMMA}) will be described with reference to FIG. 19. FIG. 19 is an explanatory view schematically illustrating a state in which, in the periodic structure of the square grating, the grating layer is observed in a plan view from the side on which the incident light is incident, supposing that the waveguide layer is removed. The volume occupancy (FF Air) of the space (air) portion constituting the grating layer (square grating periodic structure) in the grating layer is determined by the following equation (1).

$${FF}_{Air} = {\{ ( Λ - w ) / Λ \}}^{2} \qquad ( 1 )$$

Therefore, FF_{PMMA} is determined by the following equation (2).

$${FF}_{PMMA} = 1 - {FF}_{A i r} \qquad ( 2 )$$

In the one dimensional grating shape illustrated in FIG. 3, FF_{Air} is determined by the following equation (3), and FF_{PMMA} is determined by the above equation (2).

$${FF}_{A i r} = ( Λ - w ) / Λ \qquad ( 3 )$$

As shown in FIG. 9, it can be seen that the reflection peak wavelength shifts to a shorter wavelength side as FF_{PMMA} decreases. The same simulation was performed also on the case where the grating shape of the grating layer was changed from the square grating to a circular grating, which is also a two dimensional periodic structure. As a result, the same results as those shown in FIG. 8 were obtained except that the reflection peak wavelength shifted to a longer wavelength side by about 5 nm. Therefore, the subsequent simulations were performed on the square grating.

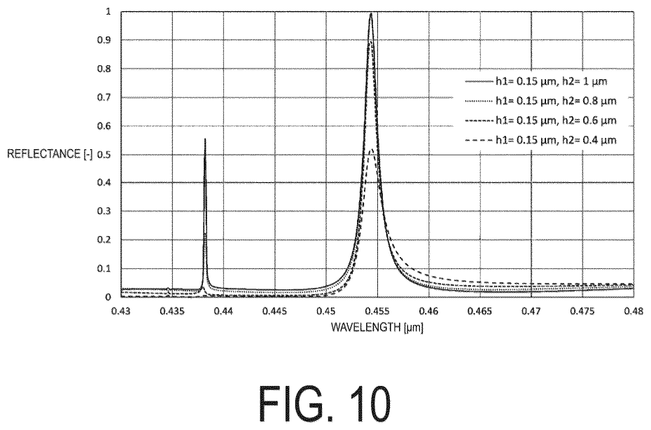

FIG. 10 shows reflection spectra when the grating period (Λ) of the grating layer is 0.340 μm, the thickness (h₁) of the waveguide layer is 0.15 μm, the grating width (w) of the grating layer is 0.108 μm, and the thickness (h₂) of the grating layer is changed. As shown in FIG. 10, it can be seen that, when the thickness (h₂) of the grating layer decreases, the height of the reflection peak decreases while the position of the reflection peak remains unchanged. From this result, it can be seen that in order to realize a high reflectance exceeding 95%, for example, it is necessary to set the thickness (h₂) of the grating layer to be large to some extent and to reduce the influence of the substrate on the waveguide layer.

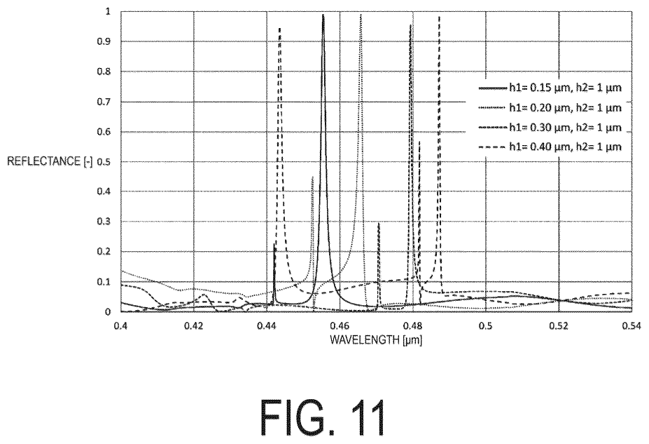

FIG. 11 shows reflection spectra when the grating period (Λ) of the grating layer is 0.340 μm, the thickness (h₂) of the grating layer is 1.00 μm, the grating width (w) of the grating layer is 0.108 μm, and the thickness (h₁) of the waveguide layer is changed. As shown in FIG. 11, it can be seen that the reflection peak wavelength shifts to the longer wavelength side as the thickness (h₁) of the waveguide layer increases.

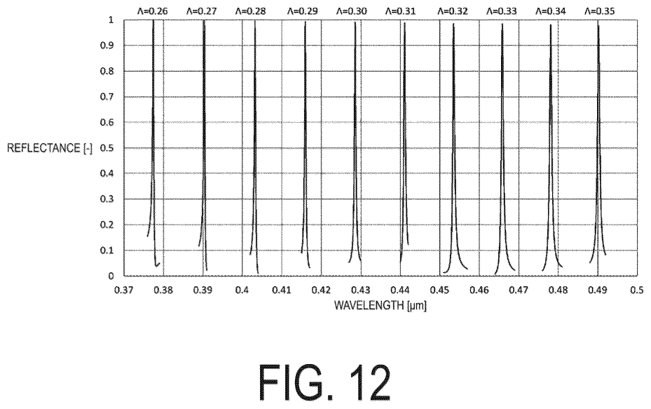

FIG. 12 shows reflection spectra when the thickness (h₁) of the waveguide layer is 0.3 μm, the grating width (w) of the grating layer is 0.08 μm, the thickness (h₂) of the grating layer is 0.5 μm, and the grating period (Λ) of the grating layer is changed. As shown in FIG. 12, it has been found that, even when the thickness of the grating layer (h₂) is decreased to 0.5 μm, an excellent reflectance exceeding 98% can be realized when the thickness of the waveguide layer (h₁) is increased to 0.3 μm. It has also been found that, as the grating period (Λ) of the grating layer decreases, the reflection peak wavelength shifts to a lower wavelength side and the peak tends to become higher and sharper.

From the above examination results, it can be seen that a GMRG that reflects light of a desired wavelength with extremely high efficiency can be provided by controlling the relationship among the grating period (Λ) of the grating layer, the thickness (h₁) of the waveguide layer, and the grating width (w) or FF of the grating layer while ensuring the thickness (h₂) of the grating layer to be at least a certain value.

The above examination has been mainly made on the adjustment of the reflection peak wavelength in the blue wavelength region. However, when the results shown in Table 1 and FIG. 8 are also taken into consideration, it can be naturally understood that, when the grating period (Λ) and the grating width (w) or FF is controlled, a GMRG having reflection peak wavelengths in the green and red wavelength regions can be provided, and a design in which light having desired wavelengths in these wavelength regions can be highly efficiently reflected can be achieved.

From the above examination results, in the GMRG of the present invention, the grating period of the grating layer can be appropriately designed in accordance with the target reflection peak wavelength within the range in which the GMRG functions as a GMRG. In order that the reflection peak wavelength is present in the visible light region, the grating period of the grating layer is preferably from 0.26 to 0.60 μm, and more preferably from 0.27 to 0.56 μm from the results of FIGS. 4 and 12.

From the results of FIG. 9, the volume occupancy of the grating layer is preferably from 0.15 to 0.65, and more preferably from 0.20 to 0.60.

In addition, the thickness of the grating layer is preferably 0.20 μm or more, usually from 0.40 to 2.00 μm, more preferably from 0.60 to 2.00 μm, and further preferably from 0.80 to 1.20 μm from the results of FIG. 7.

From the results of FIG. 6, the thickness of the waveguide layer is preferably from 0.05 to 1.00 μm, more preferably from 0.05 to 0.90 μm, further preferably from 0.05 to 0.40 μm, still further preferably from 0.10 to 0.30 μm, and particularly preferably from 0.20 to 0.30 μm as a range in which a single peak appears.

In the GMRG of the present invention, the grating shape of the grating layer (the shape of the hole (space) of the concave portion when the grating layer is observed in a plan view in the same manner as described above) is not particularly limited. The grating shape of the grating layer is also preferably rectangular (in the present invention, the term “rectangular” has the meaning including both a square and a rectangle), and, in this case, more preferably square. In the present invention, the term “rectangular” means a substantially rectangular shape. For example, in addition to a shape in which all of the four corners have a right angle, the four corners may have an angle in a vicinity of 90 degrees or may be rounded, as long as characteristics equivalent to those of the shape in which all the four corners have a right angle are exhibited. Further, in the GMRG of the present invention, the grating shape of the grating layer may be circular or elliptical.

In addition, it is also preferable that the grating shape of the grating layer has a structure in which irregularities are reversed from those of the above-described structure, that is, the shape of the convex portion (grating material portion) is rectangular, circular, elliptical, or the like as described above when the grating layer is observed in a plan view in the same manner as described above. In this case, FF Air in the above calculation equation becomes FF_{PMMA}.

In the GMRG of the present invention, at least the grating layer and the waveguide layer are preferably made of a resin (preferably a thermoplastic resin). Examples of such a resin include transparent resins such as acrylic resins, polystyrene resins, ABS resins, polyethylene resins, polypropylene resins, polycarbonate resins, fluorine resins, vinyl chloride resins, and nylon resins. When the GMRG of the present invention has a substrate on the side of the grating layer opposite to the waveguide layer, the constituent material for the substrate is not particularly limited. When the substrate is formed of a transparent material, the substrate can be made of, for example, silica, quartz, a resin, or the like. When the constituent material for the substrate is a resin, examples thereof include an acrylic resin, a polystyrene resin, an ABS resin, a polyethylene resin, a polypropylene resin, a polycarbonate resin, a fluorine resin, a vinyl chloride resin, and a nylon resin.

### Method for Manufacturing Guided-Mode Resonant Grating

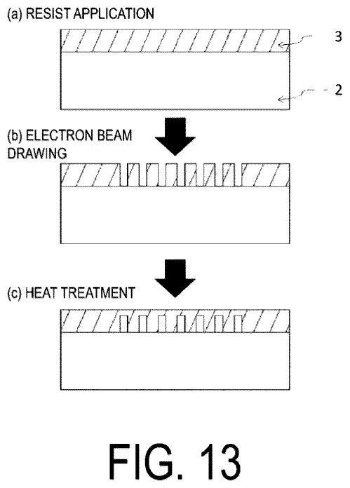

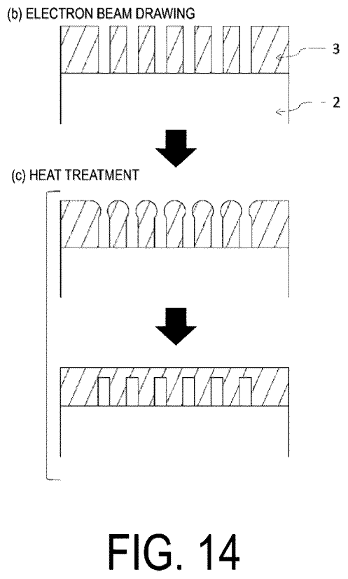

An example of a method for manufacturing the GMRG of the present invention will be described with reference to FIGS. 13 and 14. The following drawings are schematic explanatory views for illustrating the method for manufacturing the GMRG of the present invention.

In the manufacturing method illustrated in FIG. 13, a resist film 3 formed on a substrate 2 is patterned to form a grating periodic structure (FIGS. 13(a) and 13(b)), and a grating surface of the grating periodic structure is thermally melted to deform the surface and a vicinity thereof, and adjacent gratings are joined to form a waveguide layer (FIG. 13(c)). FIG. 14 illustrates FIGS. 13(b) to 13(c) in more detail. The waveguide layer can be formed by applying heat to an upper portion of the grating of the grating periodic structure to melt and deform only the grating surface (the upper surface of the grating in FIG. 14) or the vicinity thereof, and joining adjacent gratings to each other.

The heating can be performed, for example, by pressing a hot plate against the grating surface while cooling the substrate 2.

Further, since a surface/volume ratio is the largest at the grating surface (grating tip portion), an effective melting point or glass transition temperature becomes low. Thus, when the entire grating is heated, the grating tip portion begins to deform first. Therefore, the waveguide layer can also be formed by heating the entire grating at an appropriate temperature between the glass transition temperature and the melting point of the grating material.

The above-described method can provide a GMRG in which the grating layer and the waveguide layer are made of the same material (for example, acrylic resin). Further, the substrate can be made of the same material.

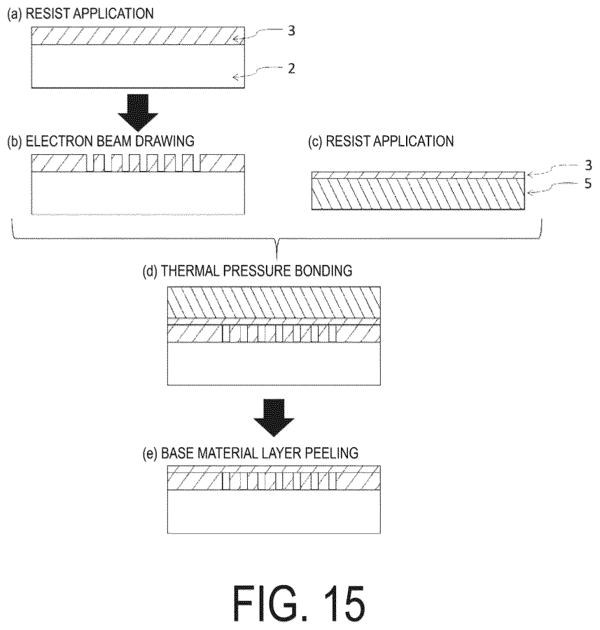

As another example of the method for manufacturing the GMRG of the present invention, there is a method in which a resist film on a substrate is patterned into a grating shape to form a grating periodic structure, a resin film is further provided on a grating surface of the grating periodic structure, and the resin film is used as a waveguide layer. An example of the method will be described with reference to FIG. 15.

In the method illustrated in FIG. 15, first, the resist film 3 is applied onto the substrate 2, and the resist film is patterned into a desired grating shape by electron beam (EB) drawing to form a grating periodic structure (FIGS. 15(a) and 15(b)). Separately, a resist (3, resin) for forming a waveguide layer is applied onto a base material 5 made of a silicone resin or the like (FIG. 15(c)). After the grating surface of the grating periodic structure and the resist for forming a waveguide layer are pressure-bonded by thermal pressure bonding or the like (FIG. 15(d)), the base material 5 is peeled off (FIG. 15(e)). Thus, a layered structure of the grating layer and the waveguide layer can be formed on the substrate.

If the resist film (3, resin) on the substrate 2 and the resist film (3, resin) for forming a waveguide layer are made of the same material, a GMRG in which the grating layer and the waveguide layer are made of the same material (for example, acrylic resin) can be obtained. The substrate 2 can also be made of the same material.

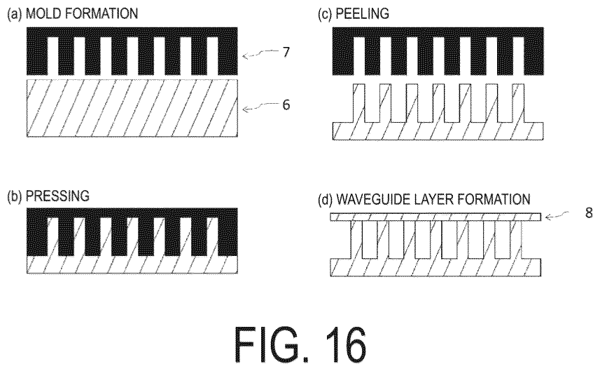

Still another example of the method for manufacturing the GMRG of the present invention will be described with reference to FIG. 16.

The method illustrated in FIG. 16 utilizes a nanoimprinting technique. First, a mold 7 is pressed against a resin base material 6 (FIGS. 16(a) and 16(b)). Then, the mold 7 is removed to form a grating periodic structure in the resin base material 6 (FIG. 16(c)). By forming a waveguide layer (8, resin film) on the grating surface of the grating periodic structure, a layered structure (FIG. 16(d)) of the substrate, the grating layer, and the waveguide layer can be formed.

Examples of a method of forming the resin film serving as the waveguide layer 8 include a method in which only the grating surface or the vicinity thereof is melted and deformed, and adjacent gratings are joined, and a method in which a resist film (resin film) for forming a waveguide layer is subjected to pressure bonding (for example, thermal pressure bonding) (pressure bonding method).

Alternatively, the resin film serving as the waveguide layer 8 can be formed by a spin coating method. That is, the waveguide layer 8 can be formed by coating a dropped resin to cover the surface without completely filling the grooves (holes) of the grating periodic structure by utilizing centrifugal force of spin coating.

Alternatively, the resin film serving as the waveguide layer 8 can be formed by a vapor deposition method or a sputtering method. That is, by granulating the resin by a vapor deposition method or a sputtering method and attaching resin particles to the grating periodic structure from an oblique direction by tilting the resin base material on which the grating periodic structure is formed, a film can be formed in such a manner that it closes openings of the grating periodic structure without the resin particles entering the bottoms of the grooves (holes) of the grating periodic structure, and the obtained film can function as the waveguide layer 8.

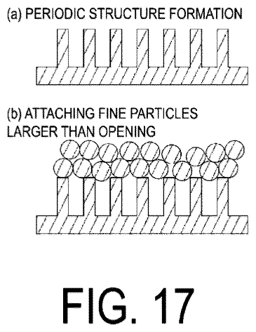

Alternatively, as illustrated in FIG. 17, resin particles larger than the width of the opening of the grating periodic structure can be deposited on the grating periodic structure to form the resin film serving as the waveguide layer 8. In this case, when the resin particles deposited on the grating periodic structure are subjected to heat treatment, pressure treatment, or the like, the adhesion between the resin particles and the adhesion between the resin particles and the grating layer can be further enhanced.

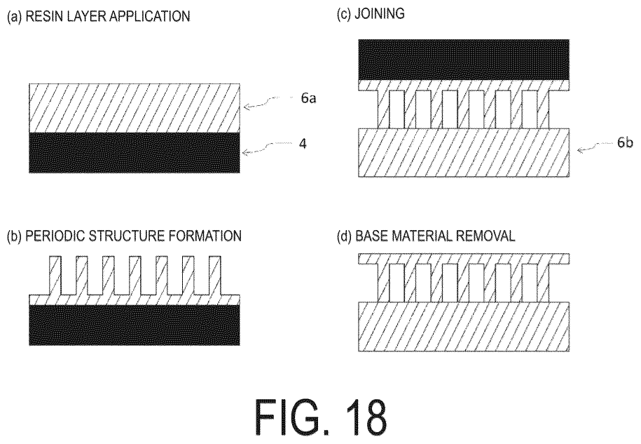

Still another embodiment of the method for manufacturing the GMRG of the present invention will be described with reference to FIG. 18. As illustrated in FIGS. 18(a) and 18(b), a resin layer 6a is formed by applying a resin onto a base material 4 made of silica, quarts, or the like, and a grating periodic structure is formed in the resin layer 6a by the nanoimprinting technique as described above, thereby forming a layered structure of a waveguide layer and a grating layer on the base material 4. Then, by removing the base material 4, a GMRG having the layered structure of the grating layer and the waveguide layer can be obtained. Before removing the base material 4, if necessary, the side of the grating periodic structure is joined to a separately prepared substrate 6b by thermal pressure bonding or the like (FIG. 18(c)), and then the base material 4 is removed to obtain a GMRG having a layered structure of the substrate, the grating layer and the waveguide layer (FIG. 18(d)).

### Application of Guided-Mode Resonant Grating

From the above-described results, the GMRG of the present invention functions as a “reflective filter” that selectively reflects incident light to a desired wavelength with high efficiency. In addition, in the GMRG of the present invention, the grating layer is not exposed on the incident light side surface but is located inside the waveguide layer, and thus irregularities of the grating layer are not directly exposed to scratching or wiping, for example, during cleaning and durability is also excellent. Further, the GMRG of the present invention can be incorporated into an optical member. Examples of such an optical member include a structural color development member, a wavelength selection filter, a dye-less paint, a polarizing filter, a colored glass, a dimmer filter, a light control filter, a fiber material (colored), a metal material (a material that develops a metal color), a hue control member, and a spectral control member.

Examples of products or semi-finished products including such an optical member include optical sensors (robots, automobiles, IoT, wearable devices, etc.), decorative articles, vehicle body coatings such as automobile body coatings, automobile components, displays, spectrometers, communication filters, light-shielding/heat-shielding materials, sunglasses, sun visors, protectors, tableware, strain sensors, force sensors, cosmetics, anti-counterfeiting materials, identification tags, clothing, ornaments (watches, accessories, cars), building materials, prints/logos on plastic containers/sheets/shields, and colored products.

As described above, the optical member or product or semi-finished product of the present invention includes the above-described GMRG of the present invention, and can have further enhanced stabilities (interlayer adhesion and durability) of the layered structure of the GMRG, and, as a result, reliability of the optical characteristics is further enhanced.

Although the present invention has been described with reference to embodiments thereof, we do not intend to limit our invention to any detail of the description unless otherwise specified. It should be broadly construed without departing from the spirit and scope of the invention as set forth in the appended claims.

The present application claims priority from the Japanese Patent Application No. 2022-104745 filed in Japan on Jun. 29, 2022, which is incorporated herein by reference in its entirety.

### REFERENCE SIGNS LIST

1 Guided-mode resonant grating
11 Low refractive index material
12 High refractive index material
2 Substrate
3 Resist film
4 Base material (silica, quartz)
5 Base material (silicone resin)
6 Resin base material
6a Resin layer (thermoplastic resin layer)
6b Substrate (resin substrate)
7 Mold (mold for forming grating periodic structure)
8 Waveguide layer (resin film)

1. A guided-mode resonant grating comprising:
a layered structure of a grating layer and a waveguide layer; and
a substrate, the grating layer, and the waveguide layer in this order, wherein
a refractive index difference between the grating layer and the waveguide layer is 0.1 or less, and light is made incident from a side of the waveguide layer, and
a constituent material for the substrate, a constituent material for the grating layer, and a constituent material for the waveguide layer are the same.

2.-4. (canceled)

5. The guided-mode resonant grating according to claim 1, wherein
the grating layer has a grating period of from 0.26 to 0.60 μm.

6. The guided-mode resonant grating according to claim 1, wherein
the grating layer has a thickness of 0.20 μm or more.

7. The guided-mode resonant grating according to claim 1, wherein
the grating layer has a volume occupancy of from 0.15 to 0.65.

8. The guided-mode resonant grating according to claim 1, wherein
the waveguide layer has a thickness of from 0.05 to 1.00 μm.

9. The guided-mode resonant grating according to claim 8, wherein a grating shape of the grating layer is a two dimensional periodic structure.

10. An optical member comprising the guided-mode resonant grating according to claim 1.

11. The optical member according to claim 10, wherein
the optical member is a structural color development member or a wavelength selection filter.

12. An optical product comprising:
the optical member according to claim 10.

13. A method for manufacturing the guided-mode resonant grating according to claim 1, comprising:
forming a grating periodic structure by patterning a resist film on the substrate, or forming a grating periodic structure by pressing a mold against a resin base material; and
forming the waveguide layer by thermally melting a grating surface of the grating periodic structure to deform the surface and a vicinity thereof and joining adjacent gratings to each other.

14. A method for manufacturing the guided-mode resonant grating according to claim 1, comprising:
forming a grating periodic structure by patterning a resist film on the substrate, or forming a grating periodic structure by pressing a mold against a resin base material; and
forming the waveguide layer on a grating surface of the grating periodic structure by a pressure bonding method, a spin coating method, a vapor deposition method, a sputtering method, or a method of depositing resin particles larger than a width of an opening of the grating periodic structure on the grating periodic structure.

15. A method for manufacturing the guided-mode resonant grating according to claim 1, comprising:
pressing a mold against a resin layer on a base material to form a grating periodic structure, and then removing the base material.

16. A method for manufacturing the guided-mode resonant grating according to claim 1, comprising pressing a mold against a resin layer on a base material to form a grating periodic structure, joining a side of the grating periodic structure onto the substrate, and then removing the base material.
